(19) United States
(12) Patent Application Publication
(10) Pub. No.: US 2015/0154773 A1
(43) Pub. Date: Jun. 4, 2015

(54) Using Geographic Coordinates On A Digital Image Of A Physical Map

(71) Applicant: Google Inc., (US)

(72) Inventors: Roberto Cosenza, Mountain View, CA (US); Luca Zanolin, Mountain View, CA (US)

(73) Assignee: Google Inc., Mountain View, CA (US)

(21) Appl. No.: 13/737,187

(22) Filed: Jan. 9, 2013

(51) Int. Cl. G06T 11/60

(52) U.S. Cl. CPC G06T 11/60

(57) ABSTRACT

Systems and methods are disclosed for using geographic coordinates on a physical map. The system may include a mobile device having a processor and a display, where the processor receives a first input that instructs a camera to capture a digital image of a physical map. The mobile device may then display the digital image of the physical map. The mobile device may further receive a second input from a user interface, where the second input identifies a first location on the digital image of the physical map. The first location may be associated with an image pixel coordinate, and the mobile device may obtain a geographic coordinate based on this image pixel coordinate. The mobile device may then determine a transformation matrix based on the image pixel and geographic coordinates. Using the determined transformation matrix, the mobile device may determine further image pixel coordinates based on received geographic coordinates.

### BACKGROUND

Mobile devices have become commonplace. For example, a user may have a laptop, a smartphone, a tablet computer, an Internet-capable camera, or other such mobile device. The mobile device may have a variety of capabilities such as phone calling, Internet browsing, picture taking, navigation assistance, and other such capabilities.

With regard to navigation assistance, a mobile device may rely on an Internet connection to retrieve a digital map of a geographic region, and then may use geolocation techniques to navigate the user with the digital map. Alternatively, the user may visit a website using the mobile device to retrieve the digital map. The mobile device may then communicate geographic coordinates that it receives from one or more satellites to the website so that the user may identify his or her location on the digital map provided by the website.

However, there may be problems with the digital map retrieved by the mobile device or by the user. For example, the retrieved map may not have information relevant to the user. The user may desire a map showing utility lines (e.g., underground water lines, electrical lines, etc.), and the retrieved map may not have this type of information. In another example, the retrieved map may have information relevant to the user, but there may be gaps in the information (e.g., the digital map is incomplete).

Accordingly, there may be instances when the user would prefer to use a physical map of the geographic region rather than the digital map retrieved by the mobile device. However, a user may not have the equipment necessary to successfully navigate the physical map or may be uncomfortable in navigating the physical map for long durations of time.

### BRIEF SUMMARY

This disclosure provides for an apparatus for aligning geographic coordinates on a digital image of a physical map. In one embodiment, the apparatus includes a display device configured to display a digital image of a physical map and a computer-readable memory. The computer-readable memory may store the digital image of the physical map and a transformation matrix that establishes a relationship between a first image coordinate and a first geographic coordinate, wherein the first image coordinate corresponds to a pixel on the digital image of the physical map and the first geographic coordinate corresponds to a geographical location of a mobile device.

The apparatus may also include a processor in communication with the computer-readable memory, where the processor is configured to display the digital image of the physical map on the display device, receive input from a user interface, the input identifying a first location on the displayed digital image, the first location being associated with the first image coordinate, and obtain the first geographic coordinate, the first geographic coordinate being associated with the first image coordinate of the displayed digital image. The processor may also be configured to determine a transformation matrix that establishes a relationship between the first image coordinate and the first geographic coordinate, and display a graphical element at a second location on the digital image. In one embodiment, the the graphical element identifies the geographical location of the mobile device, and the graphical element is associated with a second image coordinate and a second geographic coordinate, the second image coordinate being determined based on the transformation matrix and the second geographic coordinate.

In another embodiment of the apparatus, the apparatus may further include an image capturing device configured to capture the digital image of the physical map, wherein the apparatus may be further configured to receive additional input that instructs the image capturing device to capture the digital image of the physical map.

In a further embodiment of the apparatus, the first image coordinate comprises a plurality of coordinates, and the transformation matrix may comprise a plurality of rows, each row corresponding to one of the plurality of coordinates.

In yet another embodiment of the apparatus, the transformation matrix may be determined based on the equation:

$$[ {x}_{1} , {y}_{1} , 1 ] \times [ \begin{matrix}a , b , 0 \\ d , e , 0 \\ g , h , 1\end{matrix} ] = [ \begin{matrix}{x}_{2} \\ {y}_{2} \\ 1\end{matrix} ]$$

where:

x₁ is an x-coordinate of the first geographic coordinate;

y₁ is a y-coordinate of the first geographic coordinate;

x₂ is an x-coordinate of the first image coordinate;

y₂ is a y-coordinate of the first image coordinate; and

a-g are coefficients of the transformation matrix used to determine (x₂, y₂) given (x₁, y₁).

In another embodiment of the apparatus, the processor may be further configured to receive a plurality of additional inputs from the user interface, wherein each of the plurality of additional inputs is associated with a different location on the digital image of the physical map and a different coordinate corresponding to each different location. In addition, the processor may determine the transformation matrix based on the plurality of inputs from the user interface.

In a further embodiment of the apparatus, the processor may determine the transformation matrix after the plurality of inputs equals or exceeds a predetermined number of inputs.

In yet another embodiment of the apparatus, the processor may be further configured to receive additional input from the user interface, the additional input identifying a third location on the displayed image of the physical map, wherein the third location is associated with a third geographic coordinate. The processor may also be further configured to re-determine the transformation matrix based on the first image coordinate and the third geographic coordinate.

In yet a further embodiment of the apparatus, the third location may include a different geographic location than the first geographic location.

This disclosure also provides for a method for aligning geographic coordinates to user-selected coordinates on a digital image of a physical map. In one embodiment of the method, the method may include displaying, on a display in communication with a processor, a digital image of a physical map, and receiving a first input from a user interface in communication with the processor, the first input identifying a first location on the digital image of the physical map, wherein the first location is associated with a first image coordinate. The method may also include obtaining a first geographic coordinate corresponding to the first image coordinate, and determining, with the processor, a transformation matrix based on the first image coordinate and the first geographic coordinate, the transformation matrix establishing a relationship between the first image coordinate and the first geographic coordinate. The method may further include displaying, on the display, a graphical element at a second location on the digital image of the physical map, the graphical element associated with a second image coordinate and a second geographic coordinate, the second image coordinate determined based on the transformation matrix and the second geographic coordinate.

In another embodiment of the method, the first image coordinate and the first geographic coordinate may be different coordinate types.

In a further embodiment of the method, the first image coordinate may include a plurality of digital image pixels and the second geographic coordinate may include a plurality of geographic coordinates.

In yet another embodiment of the method, the method may include receiving, with the processor, a second input that instructs an image capturing device to capture the digital image of the physical map, and capturing, with the image capturing device, the digital image of the physical map.

In yet a further embodiment of the method, the first image coordinate may include a plurality of coordinates, and the transformation matrix may include a plurality of rows based on the number of coordinates in the plurality of coordinates.

In another embodiment of the method, the transformation matrix may be determined based on the equation:

$$[ {x}_{1} , {y}_{1} , 1 ] \times [ \begin{matrix}a , b , 0 \\ d , e , 0 \\ g , h , 1\end{matrix} ] = [ \begin{matrix}{x}_{2} \\ {y}_{2} \\ 1\end{matrix} ]$$

where:

x₁ is an x-coordinate of the first geographic coordinate;

y₁ is a y-coordinate of the first geographic coordinate;

x₂ is an x-coordinate of the first image coordinate;

y₂ is a y-coordinate of the first image coordinate; and

a-g are coefficients of the transformation matrix used to determine (x₂, y₂) given (x₁, y₁).

In a further embodiment of the method, the method may include receiving a plurality of inputs from the user interface, wherein each input of the plurality of inputs may be associated with a different location on the digital image of the physical map and a different coordinate corresponding to each different location, and wherein determining the transformation matrix based on the first image coordinate may include determining the transformation matrix based on the plurality of inputs from the user interface.

In yet another embodiment of the method, the transformation matrix may be determined after the plurality of inputs equals or exceeds a predetermined number of inputs.

In yet a further embodiment of the method, the method may include receiving additional input from the user interface, the additional input identifying a third location on the displayed image of the physical map, wherein the third location may be associated with a third geographic coordinate. The method may also include re-determining the transformation matrix based on the first image coordinate and the third geographic coordinate.

In another embodiment of the method, the third location may be a different geographical location than the first location.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example of using a mobile device to capture a digital image of a physical map according to aspects of the disclosure.

FIG. 2 illustrates an example of a mobile device configured to use geographic coordinates on a physical map according to aspects of the disclosure.

FIGS. 3A-5B illustrate examples of calibrating the mobile device to display geographic coordinates on the digital image of the physical map according to aspects of the disclosure.

FIG. 6 illustrates an example of a calibration prompt displayed on the mobile according to aspects of this disclosure.

FIG. 7 illustrates an example of the mobile device transforming and rescaling the digital image of the physical map according to aspects of the disclosure.

FIGS. 8A-8B illustrate examples of the mobile device displaying a location of the user on the digital image of the physical map according to aspects of the disclosure.

FIGS. 9-10 illustrate an example of logic flow for using geographic coordinates with a digital image of a physical map according to aspects of the disclosure.

### DETAILED DESCRIPTION

This disclosure provides for systems and methods for using geographic coordinates on a physical map. In particular, this disclosure provides for capturing a digital image of a physical map, calibrating a mobile device to use geographic coordinates on the digital image, and then using the mobile device to display a user's location on the digital image of the physical map using the geographic coordinates. In one embodiment, capturing an image of the physical map may be performed by taking a picture of the physical map, e.g., with a camera, or by scanning it, e.g., with a scanner. When the digital image is available on the mobile device, the user may then roughly identify his or her location on the digital image, such as by pointing at a location on the digital image. After moving from this first location, the user may then identify, e.g., by pointing, on the digital image where he or she is again. After recording a few identified locations, the mobile device may then rescale and transform the digital image of the map to align the identified locations, and the mobile device may then begin displaying the user's location as the user moves through the geographic region.

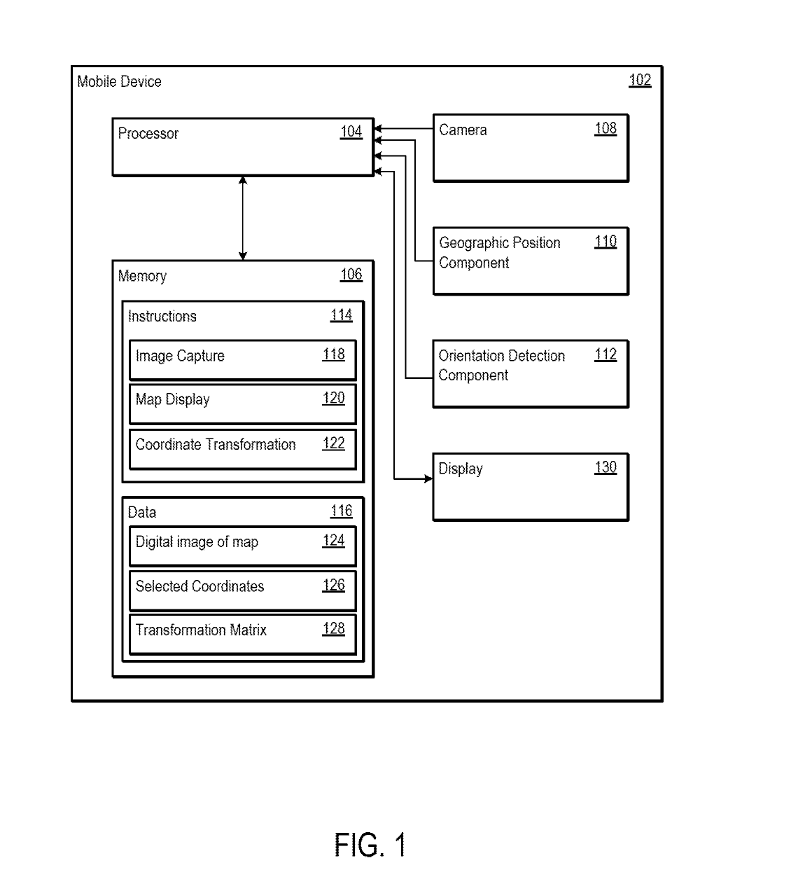

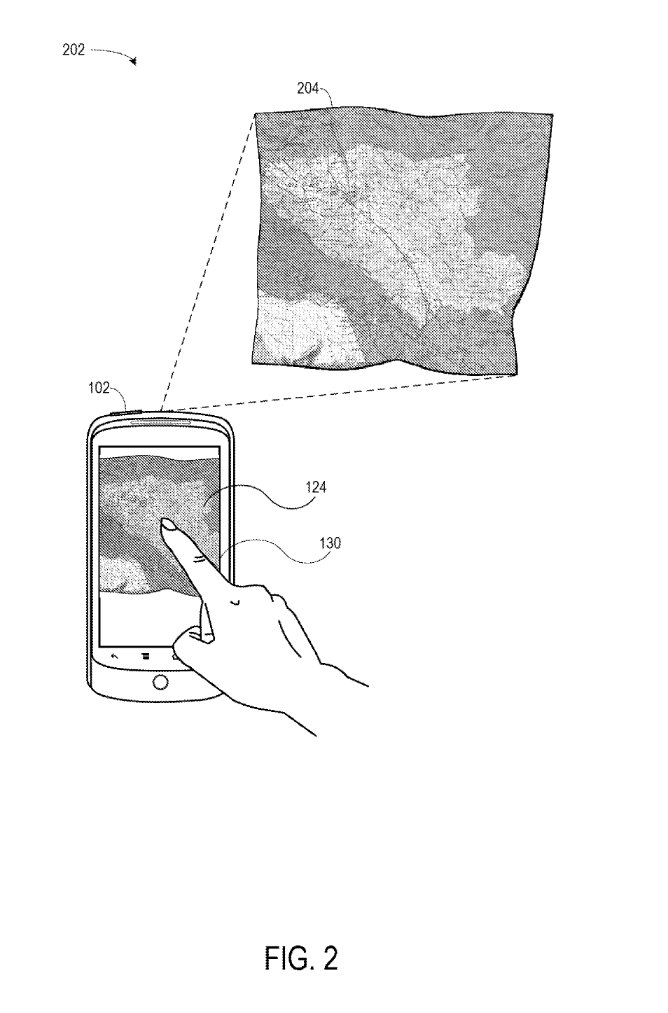

FIG. 1 illustrates a mobile device 102 in accordance with aspects of the disclosure. FIG. 2 illustrates an example 202 of a user using the mobile device 102 to capture a digital image 124 of a physical map 204. The user may use the mobile device 102, such as by touching the display 130, to identify one or more of the user's physical location on the digital image 124. The mobile device 102 may then automatically, or when instructed by the user, align geographic coordinates, such as Global Positioning System (“GPS”) coordinates, obtained by the mobile device 102 with the user's one or more identified locations on the digital image 124. In this manner, the user may use GPS coordinates with the digital image 124 of the physical map 204.

The mobile device 102 may include various components for aligning obtained geographic coordinates with the digital image 124 of the physical map 204. In general, the mobile device 102 may be any such devices as a laptop computer, media player, e-book readers, smartphone, Personal Digital Assistants (“PDA”), cellphone, tablet computer, handheld device, or any other suitable device or combination of devices. The mobile device 102 may receive the geographic coordinates from one or more geographic positioning systems, such as GPS, the Global Navigation Satellite System (“GLONASS”), and other such systems.

The mobile device 102 may include one or more components, such as a processor 104, a memory 106, a camera 108 (or other image acquisition device), a geographic position component 110, an orientation detection component 112, and a display 130. While the display 212 may function as a user interface device, the mobile device 102 may also include other user interface devices for receiving input, such as a keyboard, trackball, directional keypad, or any other such user interface device. The mobile device 102 may also receive user input from a non-tactile input device, such as a microphone (not shown) or the camera 108 (e.g., through image recognition or the like). In addition to the display 130, the mobile device may include other components for providing output, such as speakers (not shown) or connections for providing output to external devices, such as a Universal Serial Bus (“USB”) connection, a High-Definition Multimedia Interface (“HDMI”) connection, an audio connection for headphones, and other such connections.

The memory 106 may store information accessible by the processor 104, such as instructions 114 and data 116 that may be executed or otherwise used by the processor 104 to display the geographic location of the mobile device 102 on the digital image of the physical map. In general, the memory 106 may be of any type of memory operative to store information accessible by the processor 104, including a computer-readable medium, or other medium that stores data that may be read with the aid of an electronic device. Examples of the memory 106 include, but are not limited to, a hard-drive; a memory card, such as a Secure Digital (“SD”) memory card; non-volatile memory, such as non-volatile random-access memory (“NVRAM”), read-only memory (“ROM”), or other non-volatile memory; volatile memory, such as dynamic random-access memory (“DRAM”) or other random-access memory (“RAM”); as well as other write-capable and read-only memories. Systems and methods may include different combinations of the foregoing, whereby different portions of the instructions and data are stored on different types of media.

The processor 104 may be any conventional processor, including Reduced Instruction Set Computing (“RISC”) processors, Complex Instruction Set Computing (“CISC”) processors, Advanced RISC Machine (“ARM”) processors, or combinations of the foregoing. Alternatively, the processor may be a dedicated device such as an applicant-specific integrated circuit (“ASIC”).

Although FIG. 2 functionally illustrates the processor 104, the memory 106, and other elements of the mobile device 102 as being within the same block, it will be understood by those of ordinary skill in the art that the processor 104 and the memory 106 may actually comprise multiple processors and memories that may or may not be stored within the same physical housing. For example, the memory 106 may be a hard drive, memory card, or other storage media located in a housing different from that of the mobile device 102.

Accordingly, references to a processor or computer will be understood to include references to a collection of processors or computers or memories that may or may not operate in parallel. Rather than using a single processor to perform the acts described herein, some of the components, such as the camera 108 or the geographic position component 110, may each have their own processor that only performs calculations related to the component's specific function.

The mobile device 102 may also include a camera 108 in communication with the processor 104 and the memory 106. The camera 108 may include components typically found in a camera of a mobile device, such as one or more sensors (e.g., a CCD and/or CMOS sensor), one or more color filters, one or more microlenses, and one or more feature filters, such as an anti-aliasing filter and/or an infrared cutoff filter. The camera 108 may also include multiple cameras, such as where the mobile device 102 includes cameras to capture stereoscopic images, or where the mobile device 102 is configured with a front-facing camera and a rear-facing camera. As discussed below with reference to FIG. 1, the processor 104 may use the camera 108 to capture an image of the physical map.

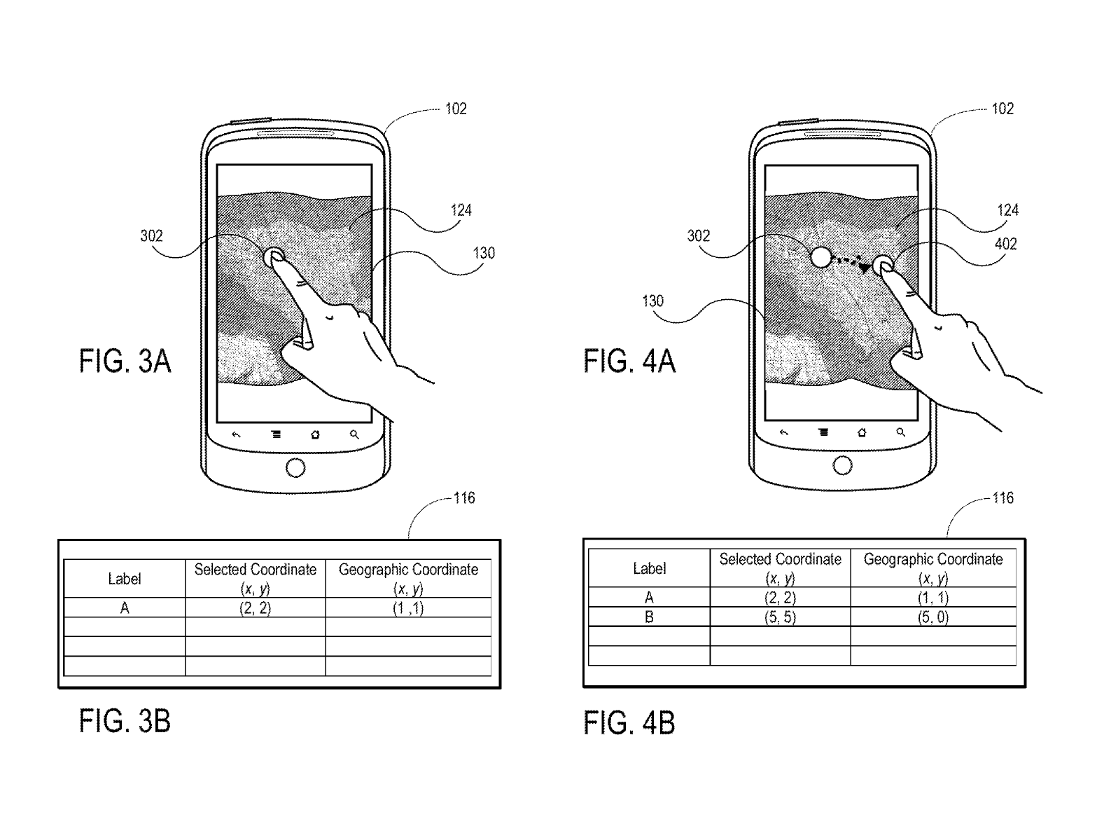

The mobile device 102 may further include a geographic position component 110, to determine the geographic location of the mobile device 102. For example, the geographic position component 110 may include a satellite receiver to receive and decode one or more coordinates from one or more geographic positioning systems, such as GPS, GLONASS, and other such systems. Based on the coordinates received from these geographic positioning systems, the geographic position component 110 may determine the mobile device's 102 latitude, longitude, and altitude. In this manner, as the mobile device 102 changes location, such as by being physically moved, the geographic position component 110 may determine a new current location for the mobile device 102. As discussed below with reference to FIGS. 3-6, the mobile device 102 may use the coordinates that the geographic position component 110 receives or determines to adjust the digital image of the physical map so that the pixels of the digital image align with the received coordinates.

The geographic position component 110 may also include software for determining the position of the mobile device 102 based on other signals that the mobile device 102 may receive, such as signals from one or more wireless network access points, signals from one or more cellular towers, or other such signals.

The mobile device 102 may also include components to determine its orientation. For example, the mobile device 102 may include one or more orientation components 210. The orientation components 210 may include an accelerometer, gyroscope, compass, magnetometer, or any combination of these components. The orientation components 210 may detect various forces acting on the mobile device 102. For example, where the orientation components 210 include an accelerometer, the accelerometer may to detect the effect of gravity on the mobile device 102 and may be measured, for example, in meters per second. The processor 104 may use input from the orientation components 210, such as the accelerometer, to determine the mobile device's 102 pitch, yaw or roll (or changes thereto) relative to the direction of gravity or a plane perpendicular thereto.

As briefly mentioned above, the memory 106 may also include instructions 114 and data 116 for using the geographic coordinates received by the geographic position component 110 with the physical map of the user. In this regard, the instructions 114 may include a set of image capture instructions 118, a set of map display instructions 120, and a set of coordinate transformation instructions 122. The data 116 may include the digital image of the physical map 204, coordinates 116 of the digital image selected by the user (discussed with reference to FIGS. 3-6), and a transformation matrix 128 that the mobile device 102 determines from the coordinates 116 selected by the user and their corresponding geographic coordinates.

Although FIG. 2 illustrates that the instructions 114 and the data 116 include instructions and data for using geographic coordinates with a digital image of a physical map, the memory 106 may also include other instructions and data typically found in a mobile device. For example, the memory 106 may include operating system instructions and data for running an operating system on the mobile device 102, phone dialing instructions and data for placing phone calls with the mobile device 102, Internet browsing instructions and data for using an Internet browser on the mobile device 102, and other such instructions and data. Moreover, the memory 106 of the mobile device 102 may be loaded or unloaded with different instructions and data according to the user's needs or desires.

In addition, the instructions 114 may be any set of instructions that may be executed directly (such as machine code) or indirectly (such as scripts) by the processor 104. For example, the instructions 114 may be stored as computer code on the computer-readable medium. In that regard, the terms “instructions” and “programs” may be used interchangeably herein. The instructions 114 may be stored in object code format for direct processing by the processor 104, or in any other computer language including scripts or collections of independent source code modules that are interpreted on demand or compiled in advance. Functions, methods and routines of the instructions 114 are explained in more detail below.

Referring back to FIG. 1, the processor 104 may execute the image capture instructions 118 when capturing the digital image 124 of the physical map. As previously discussed above, FIG. 1 illustrates the user using the mobile device 102 to capture the digital image 124 of a physical map 204. In one embodiment, image 124 the processor 104 may execute the image capture instructions 118, which may cause the camera 108 to capture the digital image 124 of the physical map 204. The digital image 124 of the physical map 204 may then be stored in the data 116 portion of the memory 106.

The data 116 may be retrieved, stored, or modified by the processor 104 in accordance with the instructions 114. For instance, although the disclosed embodiments are not limited by any particular data structure, the data 116 may be stored in computer registers, in a relational database as a table having a plurality of different fields and records, XML documents, flat files, or in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 116 may comprise any information sufficient to identify the relevant information, such as numbers, descriptive text, proprietary codes, references to data stored in other areas of the same memory or different memories (including other network locations) or information that is used by a function to calculate the relevant data.

After capturing the digital image 124 of the physical map 204, the user may then display the digital image 124 on the display 130 of the mobile device 102. As the user moves about a geographic region corresponding to the physical map 204, the user may identify where he or she is on the digital image 124 of the physical map by interacting with the mobile device 102. FIGS. 3-6 illustrate examples of the user interacting with the mobile device 102 to identify his or her location in the geographic region corresponding to the digital image 124 of the physical map. Moreover, FIGS. 3-6 illustrate the mobile device 102 associating geographic coordinates with coordinates selected by the user to determine a transformation matrix for transforming and rescaling the digital image 124 of the physical map.

In FIG. 3A, the user may identify a first location 302 on the digital image 124 where the user believes the user is located. In one embodiment, the user may identify the first location 302 by touching the display 130 of the mobile device 102. In another embodiment, the user may use a keyboard (not shown) or trackball (not shown) of the mobile device 102 to identify the user's location. In yet another embodiment, the user may use a non-tactile input, such as by speaking, to identify the user's location on the digital image 124.

In response to the identification, and as shown in FIG. 3B, the processor 104 may store the coordinates selected by the user in the data 116 portion of the memory 106. In one embodiment, the selected coordinates 116 may be stored as two-dimensional pixel coordinates (e.g., x, y) corresponding to the height and width pixel of the digital image 124 selected by the user. Alternatively, the selected coordinates 116 may correspond to the height and width location of the display 130.

The processor 104 may then instruct the geographic position component 110 to obtain geographic coordinates based upon the identification of the user's location. The geographic coordinates obtained by the geographic position component 110 may then be associated with the coordinates 116 selected by the user. As shown in FIG. 3B, the selected coordinates of (2, 2) may correspond to the geographic coordinates (1, 1) obtained by the geographic position component 110.

The user may then move the mobile device 102 to a second geographic location. The mobile device 102 may also prompt the user to move to the second geographic location. The second geographic location may be any other geographic location different than the first geographic location. The processor 104 may also determine whether the second geographic location is a predetermined distance from the first geographic location (e.g., 500 meters), such as by obtaining the geographic coordinates of the second geographic location and comparing those geographic coordinates with the first geographic coordinates of the first geographic location stored in the memory 106.

FIG. 4A illustrates an example of the user identifying the user's second location 402 on the digital image 124 of the physical map. As previously discussed, the user may identify the second location 402 by touching the display 130 of the mobile device 102, using a keyboard or a trackball, or by using a non-tactile input, such as by speaking.

In response to the identification, and as shown in FIG. 4B, the processor 104 may store the coordinates selected by the user in the data 116 portion of the memory 106. In one embodiment, the selected coordinates 116 of the second location 402 may be stored as two-dimensional pixel coordinates (e.g., x, y) corresponding to the height and width pixel of the digital image 124 selected by the user. Alternatively, the selected coordinates 116 of the second location 402 may correspond to the height and width location of the display 130.

The processor 104 may then instruct the geographic position component 110 to obtain geographic coordinates based upon the identification of the user's location. The geographic coordinates obtained by the geographic position component 110 may then be associated with the coordinates 116 selected by the user. As shown in FIG. 4B, the selected coordinates of (5, 5) of the second location 402 may correspond to the geographic coordinates (5, 0) obtained by the geographic position component 110.

The user may then move the mobile device 102 to a third geographic location. The mobile device 102 may also prompt the user to move to the third geographic location. The third geographic location may be any other geographic location different than the first or second geographic location. The processor 104 may also determine whether the third geographic location is a predetermined distance from the first or second geographic location (e.g., 500 meters), such as by obtaining the geographic coordinates of the third geographic location and comparing those geographic coordinates with the first and/or second geographic coordinates of the first geographic location and/or second geographic location stored in the memory 106.

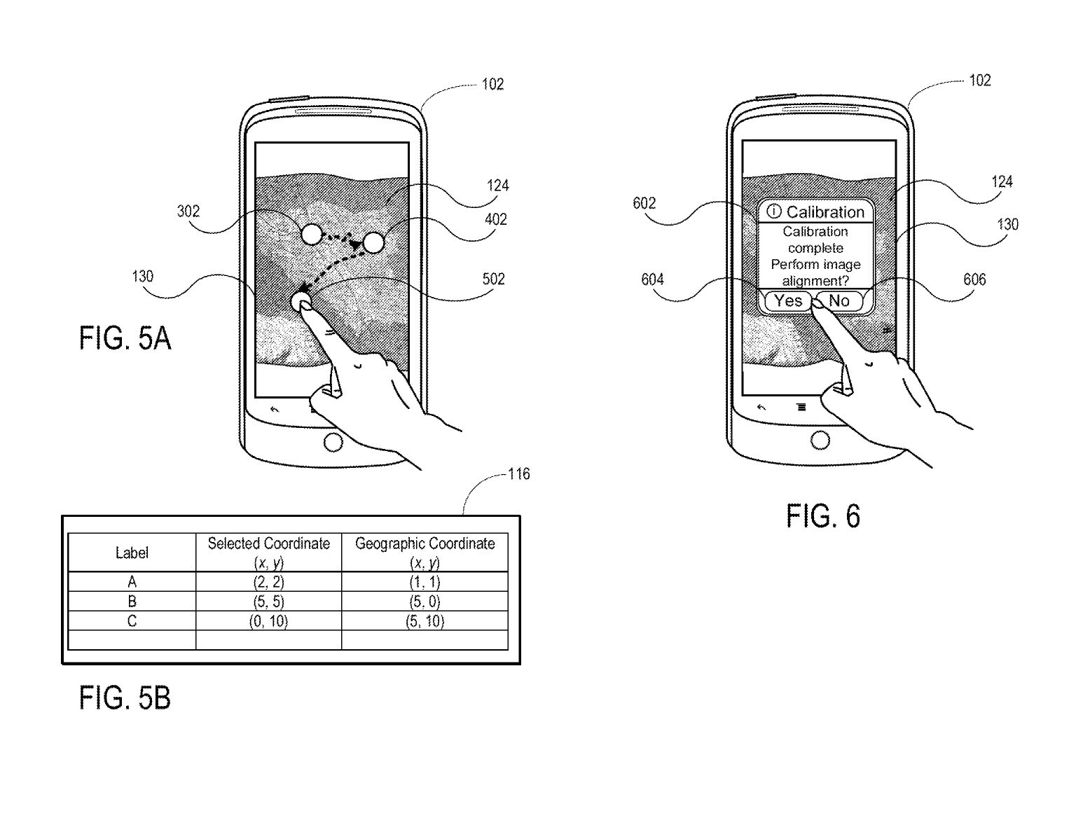

FIG. 5A illustrates an example of the user identifying the user's third location 502 on the digital image 124 of the physical map. As previously discussed, the user may identify the third location 502 by touching the display 130 of the mobile device 102, using a keyboard or a trackball to perform the identification, or by using a non-tactile input, such as by speaking.

In response to the identification, the processor 104 may store the coordinates selected by the user in the data 116 portion of the memory 106. In one embodiment, the selected coordinates 116 of the third location 502 may be stored as two-dimensional pixel coordinates (e.g., x, y) corresponding to the height and width pixel of the digital image 124 selected by the user. Alternatively, the selected coordinates 116 of the third location 502 may correspond to the height and width location of the display 130.

The processor 104 may then instruct the geographic position component 110 to obtain geographic coordinates based upon the identification of the user's location. The geographic coordinates obtained by the geographic position component 110 may then be associated with the coordinates 116 selected by the user. As shown in FIG. 5B, the selected coordinates of (0, 10) of the third location 502 may correspond to the geographic coordinates (5, 10) obtained by the geographic position component 110.

After receiving the various pairs of selected/geographic coordinates, the processor 104 may determine the transformation matrix 128. In general, the transformation matrix 128 establishes a relationship between the coordinates selected by the user (e.g., the pixel coordinates) and the geographic coordinates obtained by the geographic position component 110. Using the transformation matrix 128, the processor 104 may transform and/or rescale the digital image 124 of the physical map 204 so that the locations and/or pixels on the digital image 124 better align with their corresponding geographic coordinates.

In another embodiment, the data 116 may include a geographic location threshold that the processor 104 uses to determine when the processor 104 should determine the transformation matrix 128. In this embodiment, the geographic location threshold may indicate that the mobile device 102 should obtain three different geographic locations from the user before determining the transformation matrix 128. In other words, when the mobile device 102 has obtained three different sets of geographic coordinates, the mobile device 102 may then determine the transformation matrix 128. However, the geographic location threshold may be higher or lower.

In addition, the mobile device 102 may support determining the transformation matrix 128 with additional pairings of selected coordinates and geographic coordinates over the geographic location threshold. More particularly, there is a correlation between the preciseness of the transformation matrix 128 and the number of obtained pairings of selected coordinates and geographic coordinates. That is, as the number of obtained pairings increases, the accuracy of the transformation matrix 128 also increases. Thus, in one embodiment, the mobile device 102 may prompt the user that additional pairings may increase the accuracy/preciseness of the alignment between the pixels of the digital image 124 and their corresponding geographic coordinates.

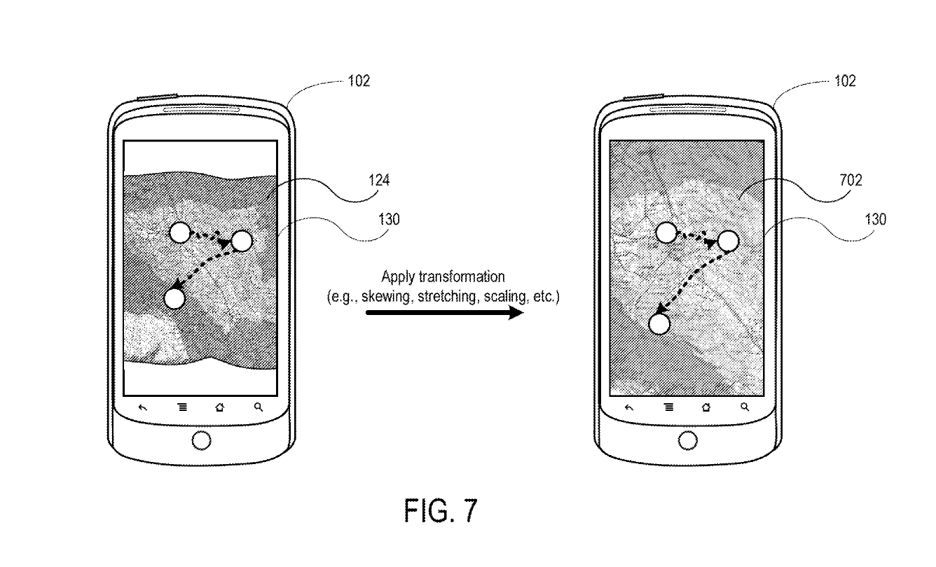

FIG. 6A illustrates an example of the mobile device 102 prompting the user whether to perform the alignment of the digital image 124 with the received geographic coordinates. In particular, the mobile device 102 has determined that it has sufficient selected/geographic coordinate pairs to determine the transformation matrix (i.e., three pairs of selected/geographic coordinates). In one embodiment, the mobile device may display a prompt 602, where the prompt 602 has graphical elements 604/606 (i.e., “Yes” and “No”) that the user may select for enabling the alignment feature.

Where the user selects the graphical element 604 (i.e., “Yes”), the mobile device 102 may proceed to determine the transformation matrix 128 and to rescale the digital image 124 accordingly. Determining the transformation matrix 128 and rescaling the digital image 124 are discussed with reference to FIG. 7.

However, where the user selects the graphical element 606 (i.e., “No”), the mobile device 102 may continue receiving selections of the user's location and associating the selected locations with geographic coordinates. This method of continuously receiving selected coordinates and associating them with the geographic coordinates to create selected/geographic coordinates pairs may continue a predetermined number of times (e.g., two times, three times, etc.). Alternatively, or in addition, the mobile device 102 may display a graphical element (not shown) on the display 130 that the user may select to manually initiate the calibration/alignment procedure (i.e., the determination of the transformation matrix 128 and/or the transformation and rescaling of the digital image 124).

In determining the transformation matrix 128, the processor 104 may execute one or more coordinate transformation instructions 122. The coordinate transformation instructions 122 may include one or more algorithms for determining the transformation matrix 128.

Determining the transformation matrix 128 may be generally represented by the equation:

$$[ {x}_{1} , {y}_{1} , 1 ] \times [ \begin{matrix}a , b , 0 \\ d , e , 0 \\ g , h , 1\end{matrix} ] = [ \begin{matrix}{x}_{2} \\ {y}_{2} \\ 1\end{matrix} ]$$

where:

X₁ is the x-coordinate of the geographic coordinate;

y₁ is the y-coordinate of the geographic coordinate;

x₂ is the user-selected co x-coordinate corresponding to x₁;

y₂ is the user-selected y-coordinate corresponding to y₁; and,

a-g are the various coefficients of the transformation matrix 128 used to determine (x₂, y₂) given (x₁, y₁).

Moreover, for each pair of selected/geographic coordinates, there may be a row in the transformation matrix 128. Hence, in the examples shown in FIGS. 3-6, the transformation matrix 128 may have three rows. However, should there be four pairs of selected/geographic coordinates, the transformation matrix 128 may have four rows. Accordingly, the number of rows in the transformation matrix 128 may increase for each pair of selected/geographic coordinates added to the memory 106.

Substituting the x-coordinate and y-coordinate for each pair of selected/geographic coordinates in the transformation equation yields three separate transformation equations to solve simultaneously, namely:

$$[ 1 , 1 , 1 ] \times [ \begin{matrix}a , b , 0 \\ d , e , 0 \\ g , h , 1\end{matrix} ] = [ \begin{matrix}2 \\ 2 \\ 1\end{matrix} ]$$

which represents the selected/geographic coordinate pair of (2, 2) and (1, 1);

$$[ 5 , 0 , 1 ] \times [ \begin{matrix}a , b , 0 \\ d , e , 0 \\ g , h , 1\end{matrix} ] = [ \begin{matrix}5 \\ 5 \\ 1\end{matrix} ]$$

which represents the selected/geographic coordinate pair of (5, 5) and (5, 0); and

$$[ 5 , 10 , 1 ] \times [ \begin{matrix}a , b , 0 \\ d , e , 0 \\ g , h , 1\end{matrix} ] = [ \begin{matrix}0 , \\ 10 \\ 1\end{matrix} ]$$

which represents the selected/geographic coordinate pair of (0, 10) and (5, 10).

As there are three pairs of selected/geographic coordinates from FIGS. 3-5, there are effectively six simultaneous equations to solve (i.e., three simultaneous equations to solve for the x-coordinate, and three simultaneous equations for the y-coordinate). Expanding the above transformation equations yields the six simultaneous equations to solve:

a+d+g=2

b+c+h=2

5e+g=5

5b+h=5

5e+10d+g=0

5b+10e+h=10

Reducing these equations yields:

a+d+5−5a=2

b+e+5−5b=2

g=5−5a

h=5−5b

5e+10d+5−5e=0

5b+10e+5−5b=10

Solving for the various coefficients thus yields, a=0.625, b=0.875, g=1.875, h=0.625, d=−0.5, and e=0.5. Replacing the coefficients of the transformation matrix 128 with the determined coefficients from above yields a transformation matrix 128 of:

$$[ \begin{matrix}0.625 , 0.875 , 0 \\ - 0.5 , 0.5 , 0 \\ 1.875 , 0.625 , 1\end{matrix} ]$$

In this manner, the determined transformation matrix 128 may then be used to determine coordinates on the digital image 124 of the physical map based on the geographic coordinates obtained by the geographic position component 110. Moreover, the processor 104 may use the determined transformation matrix 128 to perform corresponding transformations and/or scaling operations on the digital image 124 to align the pixels of the digital image 124 with their corresponding geographic coordinates.

Referring to FIG. 7 is an example 702 of the mobile device 102 transforming and/or rescaling the digital image 124 based on the determined transformation matrix 128. In one embodiment, the transformation of the digital image 124 may include making a copy of the digital image 124, thus preserving the original digital image 124, and then altering the copy of the digital image 124. Altering the digital image based on the transformation matrix 128 may include one or more operations on one or more portions of the digital image including, but not limited to, scaling, rotations, skewing, deskewing, translations, and other such operations. A transformed digital image 702 may then be displayed on the display 130 of the mobile device 102. As shown in FIG. 7, one or more portions of the original digital image 124 may be expanded or translated based on the determined transformation matrix 128.

In an alternative embodiment, when the user activates the calibration/alignment feature, the mobile device 102 may not alter the digital image 124. Instead, the mobile device 102 may display a graphical element (not shown) representing the location of the user. As the user moves about the geographic region, the mobile device 102 may display the graphical element on the digital image 124 at coordinates corresponding to geographic coordinates that have been translated based on the transformation matrix 128. In this manner, the digital image 124 remains unaltered, yet the user retains the benefits of being able to use geographic coordinates on the digital image 124 of the physical map.

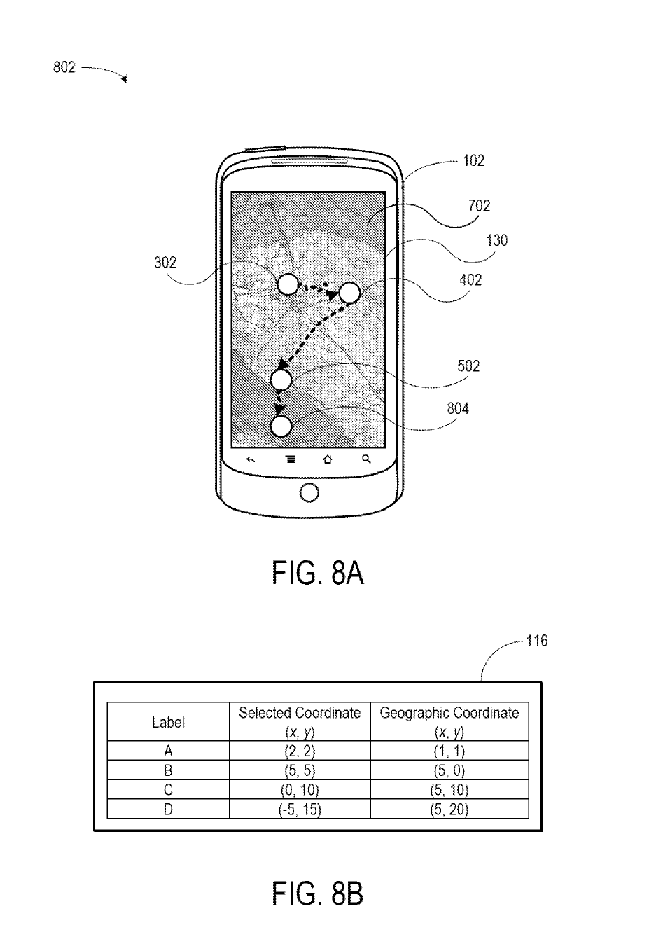

FIG. 8A illustrates an example 802 where the processor 104 has determined the transformation matrix 128, and is using the transformation matrix 128 to determine coordinates on the altered digital image 702 that correspond to received geographic coordinates. In the example 802, the user has moved the mobile device 102 to a fourth geographic location. The mobile device 102 may obtain the geographic coordinates (5, 20) that correspond to this fourth geographic location. Rather than the user providing input to the mobile device 102 as to the user's location on the altered digital image 702, the mobile device 102 may display an approximate location 804 of the user. As shown in FIG. 8B, the mobile device 102 may determine that this approximate location 804 corresponds to (−5, 15) on the altered digital image 702.

While the foregoing description of FIGS. 8A-8B is in relation to displaying the altered digital image 702, the mobile device 102 may also, or alternatively, display the original digital image 124. Accordingly, the mobile device 102 may display the user's approximate location on the original digital image 124 based on using the received geographic coordinates (5, 20) with the determined transformation matrix 128.

Moreover, when the user moves to the fourth geographic location, the user may identify the user's geographic location on the original digital image 124. In this regard, the processor 104 may re-determine the transformation matrix 128 using the fourth selected coordinates as additional input. In this example, the processor 104 may determine eight simultaneous equations based on the four selected/geographic coordinate pairs that the user provides. Thus, the input of the user's fourth geographic location may enhance the accuracy of the mobile device 102 in displaying a location of the user on the digital image (altered 702 and/or original 124) of the physical map.

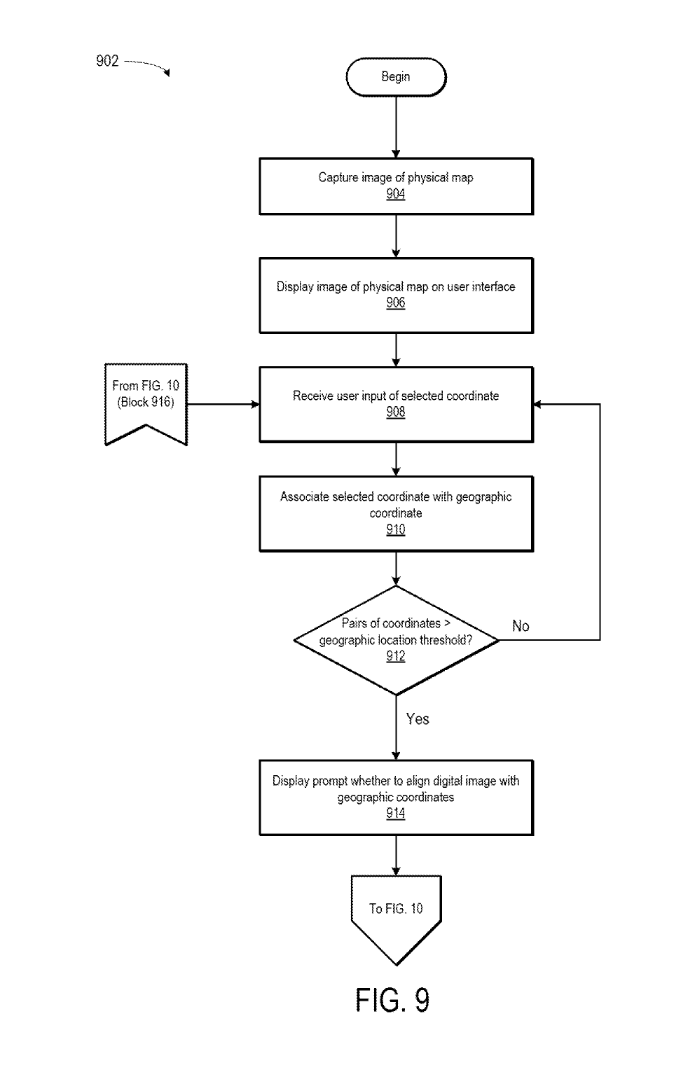

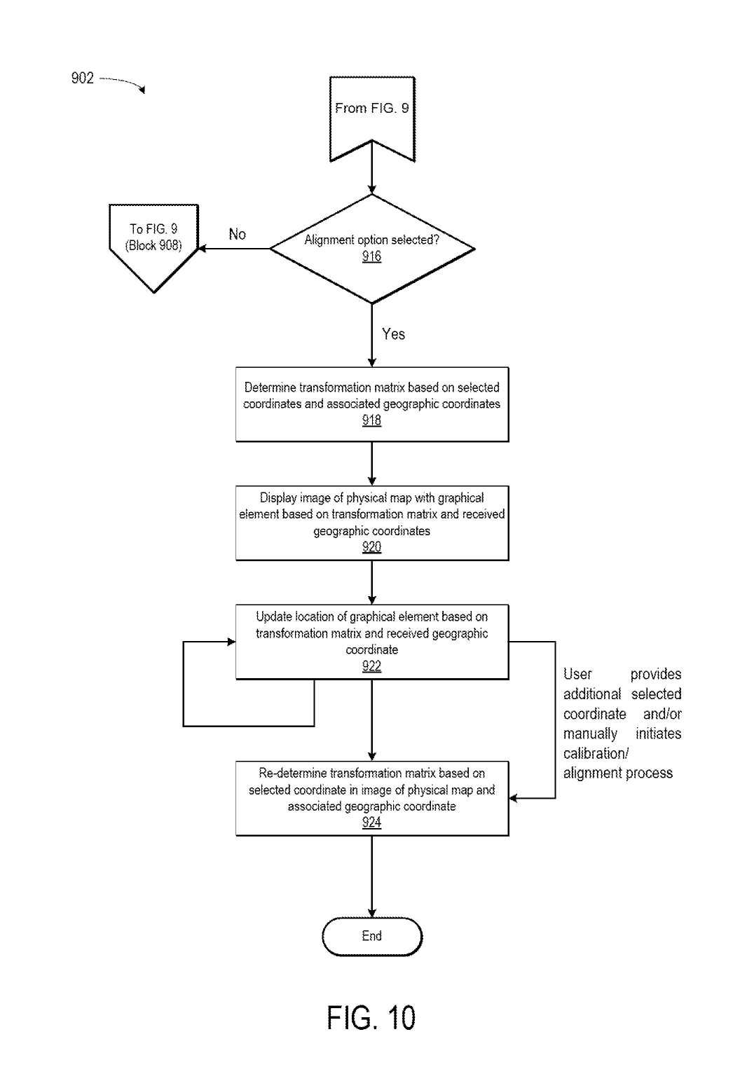

FIGS. 9-10 illustrate an example of logic flow 902 for using the geographic coordinates with the digital image 124 of the physical map 204 according to aspects of the disclosure. Initially, the mobile device 102 may receive a command to capture the digital image 124 of the physical map 204 (Block 904). As previously discussed, the processor 104 of the mobile device 102 may execute one or more image capture instructions 118 to capture the digital image 124 of the physical map 204. The digital image 124 of the physical map may be stored as data 116 in the memory 106.

The user may then instruct the mobile device 102 to display the digital image 124 of the physical map, such as by selecting a map software application from a list of applications stored on the mobile device 102. In one embodiment, the digital image 124 may be displayed on the display 130, which the user may use to interact with the digital image 124 (Block 906). Alternatively, or in addition, the mobile device 102 may be equipped with other tactile interfaces, such as a keyboard or trackball, to interact with the digital image 124. The mobile device 102 may also be equipped with non-tactile input interfaces, such as voice recognition software, for the user to use in interacting with the digital image 124.

The user may then select a position on the digital image 124 where the user believes the user is located (Block 908). The processor 104 may then store the selected coordinates in the memory 106. The processor 104 may also instruct the geographic position component 110 to obtain geographic coordinates at the time the user provides the selected coordinates. When the geographic coordinates are obtained, the processor 104 may then associate the obtained geographic coordinates with the user's selected coordinates (Block 910).

The processor 104 may then determine whether the mobile device 102 has received sufficient selected/geographic coordinate pairs to determine the transformation matrix (Block 912). In one embodiment, performing this determination may include comparing a geographic location threshold with the number of received selected/geographic coordinate pairs. The geographic location threshold may be any number of selected/geographic coordinate pairs, such as three selected/geographic coordinate pairs, four selected/geographic coordinate pairs, five selected/geographic coordinate pairs, or any other number.

Where the comparison indicates that the processor 104 has an insufficient number of selected/geographic coordinate pairs (i.e., the number of selected/geographic coordinate pairs is less than the geographic location threshold), the processor 104 may continue receiving selected coordinates from the user and associating the selected coordinates with obtained geographic coordinates. The processor 104 may also display on the display 130 the number of selected coordinates the user has provided and the number of selected coordinates the processor 104 still needs in order to determine the transformation matrix 128.

Where the comparison indicates that the processor 104 has a sufficient number of selected/geographic coordinate pairs (i.e., the number of selected/geographic coordinate pairs is greater than or equal to the geographic location threshold), the processor 104 may display a prompt on the display 130 requesting whether the user would like to proceed with the image alignment process (Block 914).

The user may then select whether to proceed with the image alignment process or to continue providing selected coordinates to the mobile device 102 (Block 916). Should the user initiate the alignment process, the processor 104 may then determine the transformation matrix 128 (Block 918). Alternatively, the user may decline the alignment process, in which case, the processor 104 may then wait for the user to provide additional selected coordinates.

In one embodiment, the processor 104 may execute one or more coordinate transformation instructions 122 to determine the transformation matrix 128. As previously discussed, the determination of the transformation matrix 128 may include evaluating a set of simultaneous equations based on the selected/geographic coordinate pairs stored in the memory 106. When the processor 104 determines the transformation matrix 128, the processor 104 may align the coordinates of the digital image 124 of the physical map with their associated geographic coordinates. In performing the alignment, the processor 104 may transform the digital image 124, such as by scaling, skewing, resizing, to obtain the altered digital image 702 that the processor 104 displays on the display 130. Alternatively, or in addition, the processor 104 may maintain the original digital image 124 for display.

The processor 104 may then display the user's approximate location on the digital image (altered 702 or original 124) based on the determined transformation matrix 128 (Block 920). As the user moves the mobile device 102, the processor 104 may update the digital image with an approximate location of the user (Block 922). Updating the user's approximate location on the digital image may include determining a pixel coordinate of the digital image that corresponds to a received geographic coordinate.

In addition, the mobile device 102 may be configured to receive a command from the user to re-determine the transformation matrix 128 (Block 924). For example, a graphical element may be displayed on the display 130 that the user may select which instructs the processor 104 to re-determine the transformation matrix 128. A non-tactile command may also be provided (e.g., using voice recognition software). In re-determining the transformation matrix 128, the processor 104 may increase the number of rows in the transformation matrix 128 based on the number of selected coordinates that the user provides. In other words, the number of rows in the transformation matrix 128 may correspond to the number of selected/geographic coordinate pairs that are stored in the memory 106. Re-determining the transformation matrix 128 may increase the accuracy of the processor 104 in aligning the coordinates of the digital image with their corresponding geographic coordinates.

In this manner, this disclosure provides systems and methods for using geographic coordinates on a physical map. In particular, the systems and methods disclosed herein may be useful when there is no publicly available, digital equivalent to the physical map. Thus, the user may scan or capture an image of the physical map, and then may use geographic coordinates with the physical map for navigation purposes. Moreover, there is a certain flexibility built into the disclosed systems such that the user may recalibrate the mobile device if the user believes that there is some inaccuracy between the user's location displayed on the image of the physical map and the user's actual location. Accordingly, the systems and methods disclosed herein provide an advantage of using geographic coordinates with a physical map.

Although aspects of this disclosure have been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of this disclosure as defined by the appended claims. Furthermore, while certain operations and functions are shown in a specific order, they may be performed in a different order unless it is expressly stated otherwise.

We claim:

1. An apparatus for aligning geographic coordinates on a digital image of a physical map, the apparatus comprising:
a display device configured to display a digital image of a physical map;
a computer-readable memory that stores:
the digital image of the physical map; and
a transformation matrix that establishes a relationship between a first image coordinate and a first geographic coordinate, wherein the first image coordinate corresponds to a pixel on the digital image of the physical map and the first geographic coordinate corresponds to a geographical location of a mobile device; and
a processor in communication with the computer-readable memory, the processor configured to:
display the digital image of the physical map on the display device;
receive input from a user interface, the input identifying a first location on the displayed digital image, the first location being associated with the first image coordinate;
obtain the first geographic coordinate, the first geographic coordinate being associated with the first image coordinate of the displayed digital image;
determine a transformation matrix that establishes a relationship between the first image coordinate and the first geographic coordinate; and
display a graphical element at a second location on the digital image, wherein:
the graphical element identifies the geographical location of the mobile device; and
the graphical element is associated with a second image coordinate and a second geographic coordinate, the second image coordinate being determined based on the transformation matrix and the second geographic coordinate.

2. The apparatus of claim 1, further comprising:
an image capturing device configured to capture the digital image of the physical map;
wherein the apparatus is further configured to receive additional input that instructs the image capturing device to capture the digital image of the physical map.

3. The apparatus of claim 1, wherein:
the first image coordinate comprises a plurality of coordinates; and
the transformation matrix comprises a plurality of rows, each row corresponding to one of the plurality of coordinates.

4. The apparatus of claim 1, wherein the transformation matrix is determined based on the equation:
$$[ {x}_{1} , {y}_{1} , 1 ] \times [ \begin{matrix}a , b , 0 \\ d , e , 0 \\ g , h , 1\end{matrix} ] = [ \begin{matrix}{x}_{2} \\ {y}_{2} \\ 1\end{matrix} ]$$
where:
x₁ is an x-coordinate of the first geographic coordinate;
y₁ is a y-coordinate of the first geographic coordinate;
x₂ is an x-coordinate of the first image coordinate;
y₂ is a y-coordinate of the first image coordinate; and
a-g are coefficients of the transformation matrix used to determine (x₂, y₂) given (x₁, y₁).

5. The apparatus of claim 1, wherein:
the processor is further configured to receive a plurality of additional inputs from the user interface, wherein each of the plurality of additional inputs is associated with a different location on the digital image of the physical map and a different coordinate corresponding to each different location; and
the processor determines the transformation matrix based on the plurality of inputs from the user interface.

6. The apparatus of claim 5, wherein the processor determines the transformation matrix after the plurality of inputs equals or exceeds a predetermined number of inputs.

7. The apparatus of claim 1, wherein the processor is further configured to:
receive additional input from the user interface, the additional input identifying a third location on the displayed image of the physical map, wherein the third location is associated with a third geographic coordinate; and
re-determine the transformation matrix based on the first image coordinate and the third geographic coordinate.

8. The apparatus of claim 7, wherein the third location comprises a different geographic location than the first geographic location.

9. A method for aligning geographic coordinates to user-selected coordinates on a digital image of a physical map, the method comprising:
displaying, on a display in communication with a processor, a digital image of a physical map;
receiving a first input from a user interface in communication with the processor, the first input identifying a first location on the digital image of the physical map, wherein the first location is associated with a first image coordinate;
obtaining a first geographic coordinate corresponding to the first image coordinate;
determining, with the processor, a transformation matrix based on the first image coordinate and the first geographic coordinate, the transformation matrix establishing a relationship between the first image coordinate and the first geographic coordinate;
displaying, on the display, a graphical element at a second location on the digital image of the physical map, the graphical element associated with a second image coordinate and a second geographic coordinate, the second image coordinate determined based on the transformation matrix and the second geographic coordinate.

10. The method of claim 9, wherein the first image coordinate and the first geographic coordinate are different coordinate types.

11. The method of claim 10, wherein the first image coordinate comprises a plurality of digital image pixels and the second geographic coordinate comprises a plurality of geographic coordinates.

12. The method of claim 9, further comprising:
receiving, with the processor, a second input that instructs an image capturing device to capture the digital image of the physical map; and
capturing, with the image capturing device, the digital image of the physical map.

13. The method of claim 9, wherein:
the first image coordinate comprises a plurality of coordinates; and
the transformation matrix comprises a plurality of rows based on the number of coordinates in the plurality of coordinates.

14. The method of claim 9, wherein the transformation matrix is determined based on the equation:
$$[ {x}_{1} , {y}_{1} , 1 ] \times [ \begin{matrix}a , b , 0 \\ d , e , 0 \\ g , h , 1\end{matrix} ] = [ \begin{matrix}{x}_{2} \\ {y}_{2} \\ 1\end{matrix} ]$$
where:
x₁ is an x-coordinate of the first geographic coordinate;
y₁ is a y-coordinate of the first geographic coordinate;
x₂ is an x-coordinate of the first image coordinate;
y₂ is a y-coordinate of the first image coordinate; and
a-g are coefficients of the transformation matrix used to determine (x₂, y₂) given (x₁, y₁).

15. The method of claim 9, further comprising:
receiving a plurality of inputs from the user interface, wherein each input of the plurality of inputs is associated with a different location on the digital image of the physical map and a different coordinate corresponding to each different location; and wherein:
determining the transformation matrix based on the first image coordinate comprises determining the transformation matrix based on the plurality of inputs from the user interface.

16. The method of claim 15, wherein the transformation matrix is determined after the plurality of inputs equals or exceeds a predetermined number of inputs.

17. The method of claim 1, further comprising:
receiving additional input from the user interface, the additional input identifying a third location on the displayed image of the physical map, wherein the third location is associated with a third geographic coordinate; and
re-determining the transformation matrix based on the first image coordinate and the third geographic coordinate.

18. The method of claim 17, wherein the third location comprises a different geographical location than the first location.
